(19) United States
(12) Patent Application Publication
(10) Pub. No.: US 2017/0228833 A1
(43) Pub. Date: Aug. 10, 2017

(54) Solar Services Matchmaking System

(71) Applicant: Jonathan Previtali, San Francisco, CA (US)

(72) Inventor: Jonathan Previtali, San Francisco, CA (US)

(21) Appl. No.: 15/018,786

(22) Filed: Feb. 8, 2016

(51) Int. Cl. G06Q 50/06; G06Q 30/02; G06Q 30/06; G06Q 20/38

(52) U.S. Cl. CPC G06Q 50/06; G06Q 20/381; G06Q 30/0201; G06Q 30/0601

(57) ABSTRACT

A design for an original Solar Services Matchmaking System is disclosed. The system leverages a human-machine interface to gather data for the establishment of unique user profiles and a set of logical software operations to automatically perform the identification and introduction (matchmaking) of parties endeavoring to provide, receive, or finance solar power projects, services and related ancillary products and services based on a prioritization of common interests, compatibilities and incompatibilities.

An international, multi-lingual, web-based, computer matchmaking and data sales system for identifying and introducing parties endeavoring to receive, provide or finance solar energy projects and services and related ancillary products and services based on a prioritization of common interests, compatibilities and incompatibilities.

### TECHNICAL FIELD

The technology relates to the general field of matchmaking software, and has certain specific application to the solar energy industry.

### BACKGROUND ART

The solar energy industry includes thousands of solar power dealers worldwide selling a diverse set of products that range from solar (electric) power and water heating systems built on roofs to those built on land, to remote solar power generated apart from where it is used, e.g. community solar power and renewable energy credits. The industry also includes financial service providers s offering funding methods such as leases, loans and power purchase agreements, and a diverse set of Solar service providers selling products such as energy storage systems for off-grid buildings, backup-up power or demand cost reduction; energy efficiency measures to better balance energy consumption with solar power and heat generation; and even electric vehicles and charging stations. Given the number and diversity of service providers and product offerings, the time and effort needed for a customer to identify an appropriate service provider and vice versa is a significant barrier to commerce. The issue also exists for project financiers seeking funding opportunities for construction and operation of new projects through service providers and vice versa. The U.S. Department of Energy has suggested that a material portion of the price of solar power is attributable to what they term the soft costs of solar, a category that includes the time and effort needed to navigate and overcome the marketing, sales and financing barriers presented by the solar industry's complex marketplace. The issue is not confined to the U.S., but is global in nature and will likely become more severe as we see growth in commercial, residential and utility scale solar power projects that are by their nature small, distributed and owned by a diverse set of players, unlike traditional, central power plants owned and operated by utilities.

### SUMMARY OF INVENTION

### Technical Problem

The technical problem the Solar Services Matchmaking System (the System) solves involves translating the manual processes used by individuals (Customers) wanting to acquire solar services, solar Power Dealers (Dealers) wanting to acquire Customers, and Solar Power Dealers and Project Financiers (Financiers) endeavoring to find each other into a low-cost and expeditious computer-based system free from the need from significant manual processes. The System will scale globally through support of international locations and languages.

### Solution to Problem

The invention solves this problem by using a typical web site infrastructure that includes a database, web server, e-mail server, e-commerce service and other typical web site infrastructure components to present in typical web and mobile phone browsers an original matchmaking system for solar industry participants. The system performs the following operations:
1. enables users to select the language of their choice among a list of major languages,
2. enables users to select locations where they desire work to occur or want projects to finance on a global basis,
3. steps users though a set of specific questions geared for the solar industry,
4. generates a unique profile for each user based on answers and other users they seek,
5. compares profiles to calculate levels of compatibility from one user to the other in a user pair and vice versa,
6. winnows user pairs with incompatibilities that prevent future commercial interaction,
7. prioritizes user pairs (Matches) based on compatibility,
8. presents the user a Match with a list of users with complimentary interests prioritized on compatibility, and
9. enables the exchange of user data between Matches free of charge or for a price,
10. supports of a network of local sales professionals (Regional Liaisons) who are motivated to market the System to their geography via a sales incentive program,
11. enables local sales professionals to set pricing appropriate for their location,
12. accepts payments in local currency, and
13. enables advertising to specific user types, e.g. Sola Power Dealers, and geographies.

FIG. 1 shows System Users and the User Network.
Admins are employed to manage the System and its users who include the following people:
   Regional Liaisons who market the System and participate in a sales incentive program,
   Solar Power Dealers who use the System to find Customers with solar power projects to build,
   Project Financiers who use the System to find Dealers with Customers and solar power projects in need of financing,
   Customers, who use the System to enter information about a potential solar power project, see Solar Power Dealers prioritized by their suitability to build the project, see reviews of the Solar Power Dealers from other Customers and select Solar Power Dealers from whom they wish to be contacted.

FIG. 2 shows Funds Flow, Pricing & Currently Support.
When a Dealer buys a Customer's Contact Details, they pay with credit card through Stripe and the Payment is deposited into the System's bank account at Wells Fargo.
A Sales Fee is taken from the Payment and applied to the Compensation Balance for the Regional Liaison based on the Project's Region.
The Origination Fee is applied to the Compensation Balance of the Regional Liaison who originated the Dealer based on the Dealer's Region. This could be same person.
The rest of the Payment is kept by the System as an Operations Fee.
When there is no Current Regional Liaison, funds are paid to the System.
Prices are set by Liaisons, presented to Customers and charged in local currencies.
Sales in local currencies are converted to USD upon transaction and deposited in the System's bank account.

FIG. 3 shows Language Support.
The System is supported by a Content Database capable of containing any number of languages.
English is the first, others will be added later.
Content Data Fields are words or phrases used by the System for all functions on screens, in emails and surveys. They are the same for each Language.
When a new Language is added, it appears on the Language List drop down.
The Language List uses the ISO 639-1 standard, shows the Language in Native Script (see Wikipedia) with its English name in the Roman alphabet in parenthesis.
Business between Dealers and Customers can be conducted in any supported Language, regardless of Region.
Business between the System and Regional Liaisons, however, is conducted in English. Hence, the content noted in the Regional Liaison Experience is only in English.

FIG. 4 shows Location Support.
The System uses four Location Levels: Continent, County, Region and Work Area.
Regions and Work Areas are based on states (or equivalent) and counties (or equivalent), respectively.
The System Admin adds Countries or Regions.
Regional Liaisons get one or more Regions to manage.
Dealers get one or more Work Areas.
Projects are associated with Work Areas.
Continents and countries are defined by ISO 3166-1, e.g. North America, USA;
Regions by ISO 3166-2,e.g., CA.
Work Areas are defined by the 2nd Level Subdivision of from various sources, customized for usability.
All Work Areas in a Supported Region will also be supported.

FIG. 5 shows the Home Screen Visitor Experience.
See Customer Experience for Language selection.
Users are presented with each of the links listed in the charts after Language Selection.
See previous Experience descriptions when noted.
The Project Map shows a map of all regions supported by the System and a dot for each Project submitted by Customers.
About us is a simple description of the company supporting the System.
If a User selects Contact Us, they choose their Country and then Region or All Regions from a drop down.
They then fill out the Contact Form.
Emails for Supported Regions go to the Regional Liaison.
Emails for Unsupported Regions and All Regions go to the System Admin.

FIG. 6 shows the Customer Experience.
When a Customer hits the site, “Language?” is shown in each language and a drop down Language List.
They choose a language and see the Project Map to find out if their Region is supported.
They enter the Project Address.
The Aerial View with a dot over the Project is shown. They adjust the dot as needed until it is over the Project.
Then they enter their Project Details, the System performs a Match and they see the Work Area's Match-Weighted Dealer List prioritized by Match Rating.
They choose up to a limited number of Dealers, enter their Customer Contact Details.
They're then offered to read the Disclaimer and submit the request for notification of the Dealers they selected.
The System sends Match Notification emails to Selected Dealers. Customer for contact.
After some months, Customer gets an email with the Customer Survey. Results are used to update Customer Ratings and Reviews.

FIG. 7 shows the Solar Power Dealer Experience.
See Customer Experience for Language selection and review of Project Map.
When signing up, Dealer enters Work Areas, Project Preferences and Contact Details.
The System sends an email with login and new password instructions.
When they get a Match Notification email, it includes Project Details, the Project's Aerial View, the Customer Price and a link to purchase.
They buy.
Then they get an email with Customer Contact Details.
At any time, they can log into the System to see Project and Contact Details of Purchased Customers, change Contact Details, Work Areas, Project Preferences Password or suspend their Account.
User name remains same always. Suspended Account data archived.

FIG. 8 shows the Project Financier Experience.
See Customer Experience for Language selection and review of Project Map.
When signing up, Financier enters Work Areas, Project Preferences and Contact Details.
The System sends an email with login and new password instructions.
When they get a Match Notification email, it includes Project Details, the Project Aerial Views, the Dealer Price and a link to purchase.
They buy.
Then they get an email with Dealer Contact Details.
At any time, they can log into the System to see Project and Contact Details of Purchased Dealers, change Contact Details, Work Areas, Project Preferences Password or suspend their Account.
User name remains same always. Suspended Account data archived.

FIG. 9 shows the Regional Liaison Experience.
A prospective Liaison selects one or more Open Regions form the Open Regions List.
They fill out the Interview Questionnaire, accept the Terms & Conditions, enter their email and physical address, and wait.
The System gets their Interview Responses via email, reviews and hires or rejects.
Liaison gets an email with the job offer and link to accept the job.
Upon acceptance, they get login and new password instructions.
Then they enter Compensation Info and set pricing for their Region.
They start work & receive payments according to the Compensation Rules.
At any time, they can login to the System to edit their Account and get project data.

As shown in FIG. 10, solar Customer profiles consist of a series of numerical scores that represent their project characteristics and can also include the importance of Solar Power Dealer characteristics to them. Similarly, Solar Power Dealer profile scores describe the importance of specific project characteristics for them. Profiles for both Customers and Solar Power Dealers can be searched by Project Financiers seeking funding opportunities associated with single projects or portfolios of projects based on specific characteristics. Importance levels are applied as multipliers to give more or less weight to specific characteristics. Characteristics that are required for a match are recorded.

The system then uses logical software operations to perform the functions of matchmaking and user pair prioritization. It starts by comparing scores in each category of characteristics for user pairs in one direction, e.g., a Customer to a Solar Power Dealer, and in the other direction, e.g., a Solar Power Dealer to a Customer. Scores for each compatible (matching) characteristic are summed; the sums are compared to the sums of scores if there were ideal compatibility and then combined into a single compatibility level for the user pair. Incompatibilities between profiles, requirements for future commercial interaction (deal breakers), are used to winnow down the list. Finally, compatibility levels for all complimentary user pairs in a logical group, e.g., Customers and Solar Power Dealers in a particular geographic region, are prioritized by compatibility level and presented to the user who has initiated the search as Matches.

Finally, the System also allows messages to be included in communications, such as emails containing Matches, to specific user types in particular geographies, e.g., Solar Power Dealers in the USA for the purposes of announcing industry news such as new solar incentive programs and advertising.

### Advantageous Effects of Invention

The invention streamlines Solar Power Dealer selection, Customer acquisition and project finance for the solar power industry on an global scale by enabling the fast and low-cost pairing and introduction of Customers, Solar Power Dealers and Financiers with mutually beneficial interests and compatibilities.

### BRIEF DESCRIPTION OF DRAWINGS

FIG. 1 Shows System Users and the User Network.

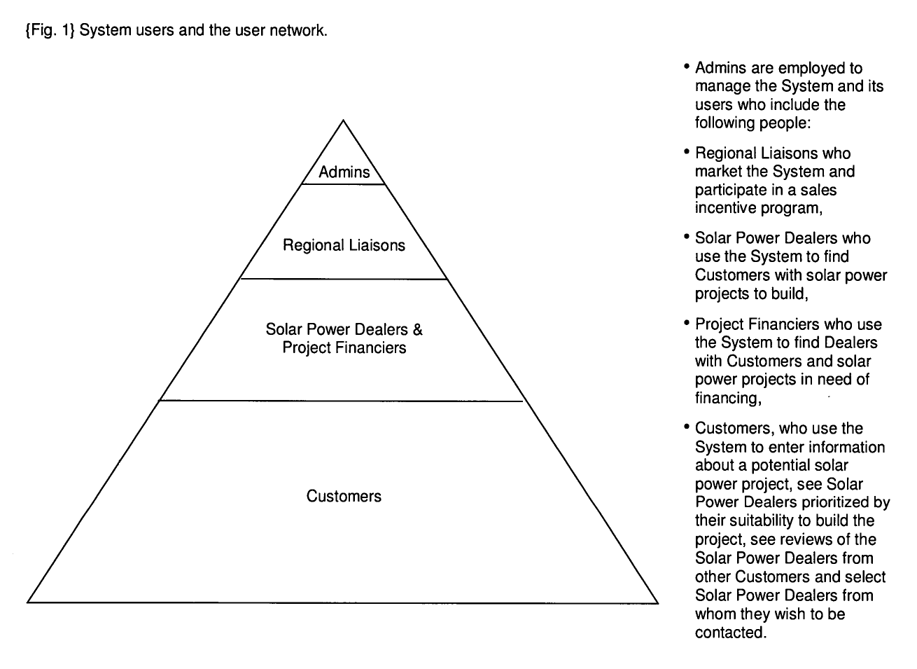

FIG. 2 Shows Funds Flow, Pricing & Currently Support.

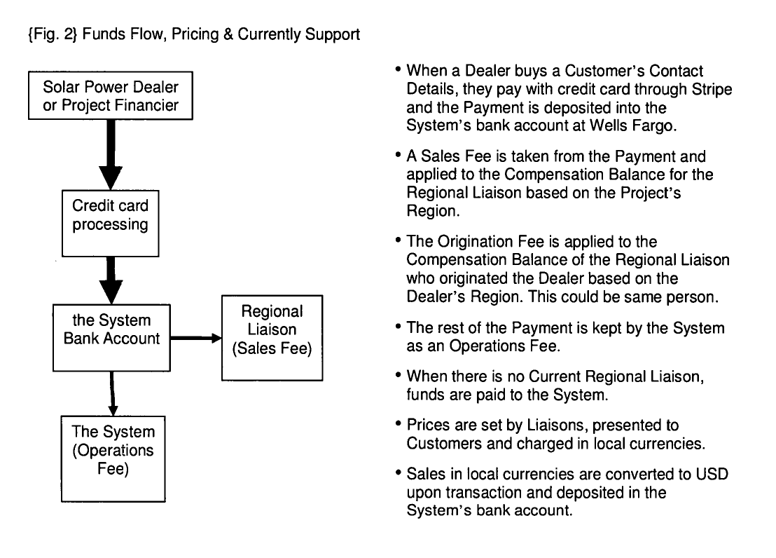

FIG. 3 Shows Language Support.

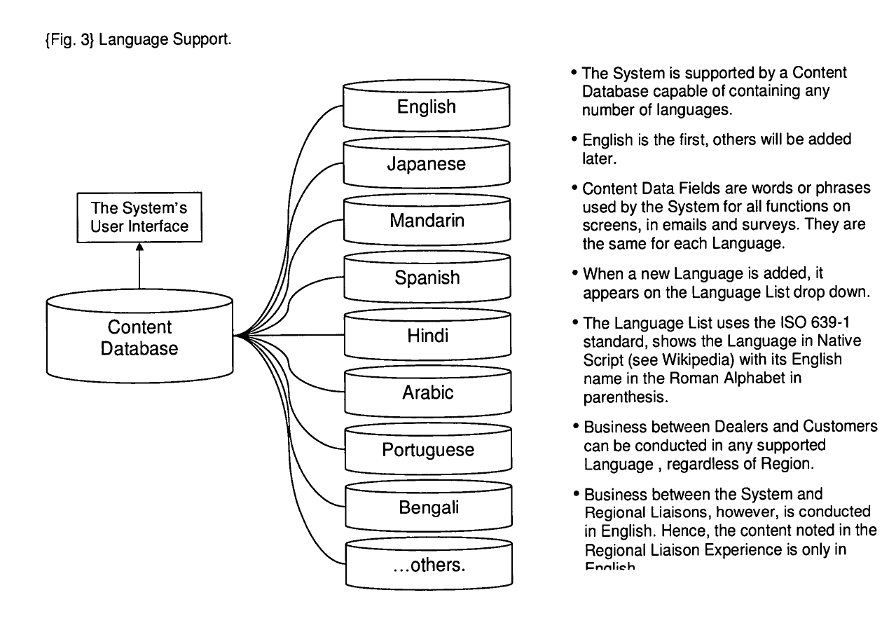

FIG. 4 Shows Location Support.

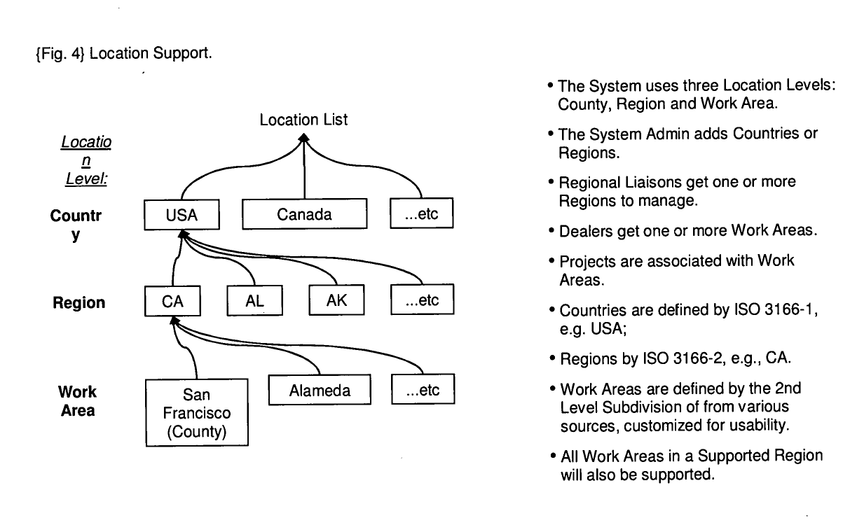

FIG. 5 Shows the Home Screen Visitor Experience.

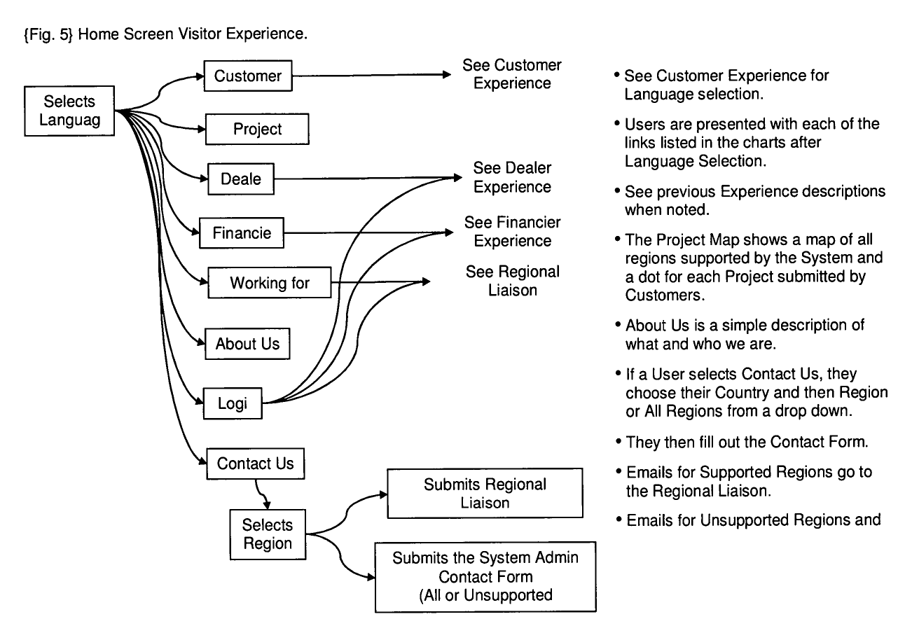

FIG. 6 Shows the Customer Experience.

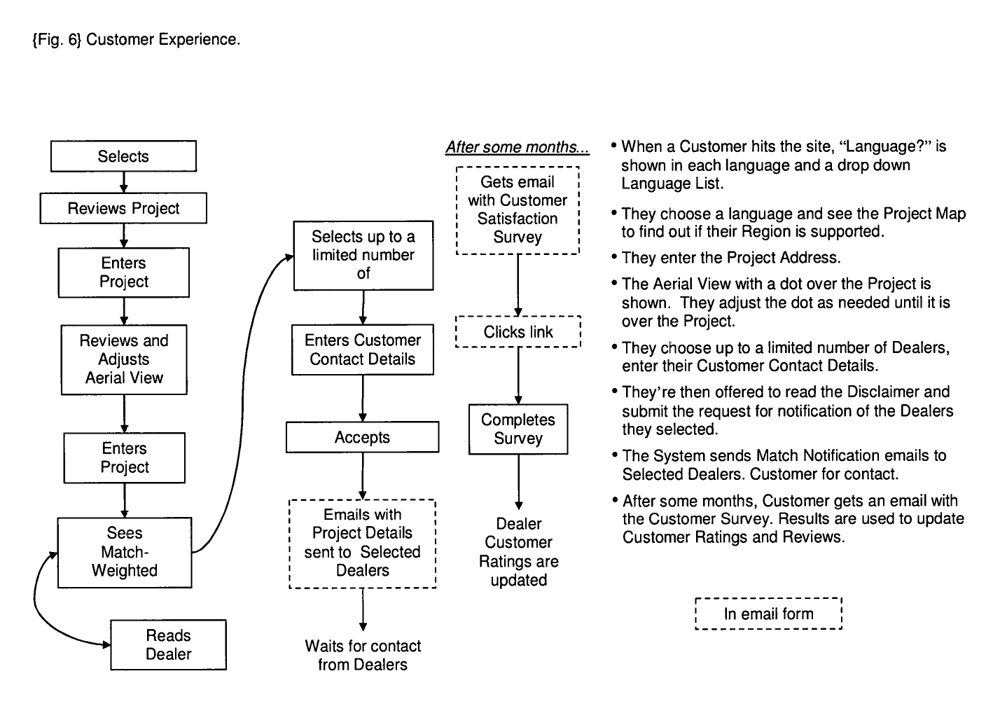

FIG. 7 Shows the Solar Power Dealer Experience.

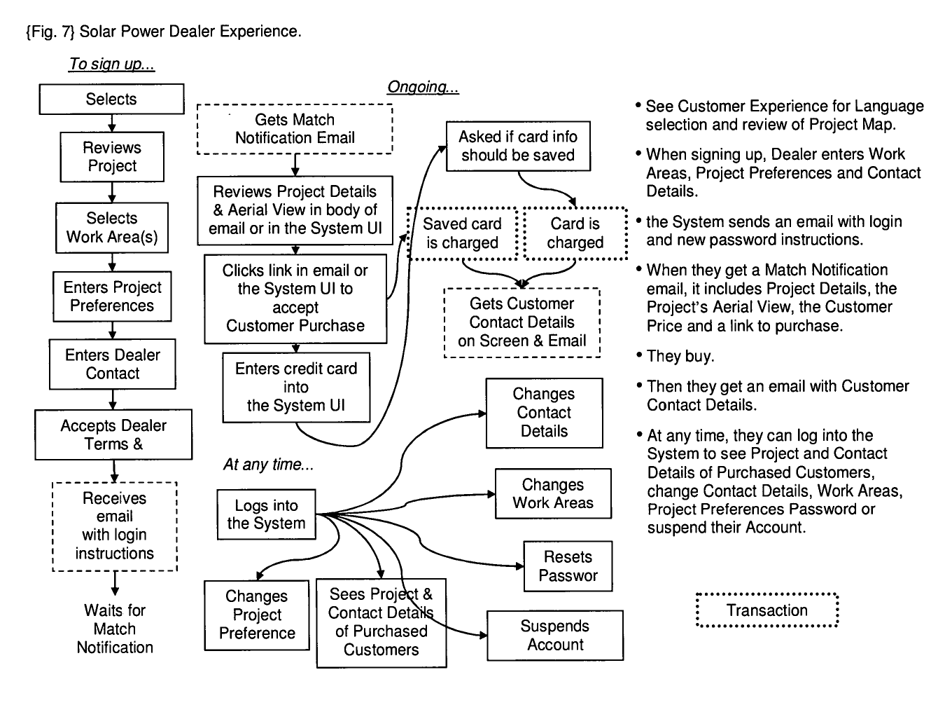

FIG. 8 Shows the Project Financier Experience.

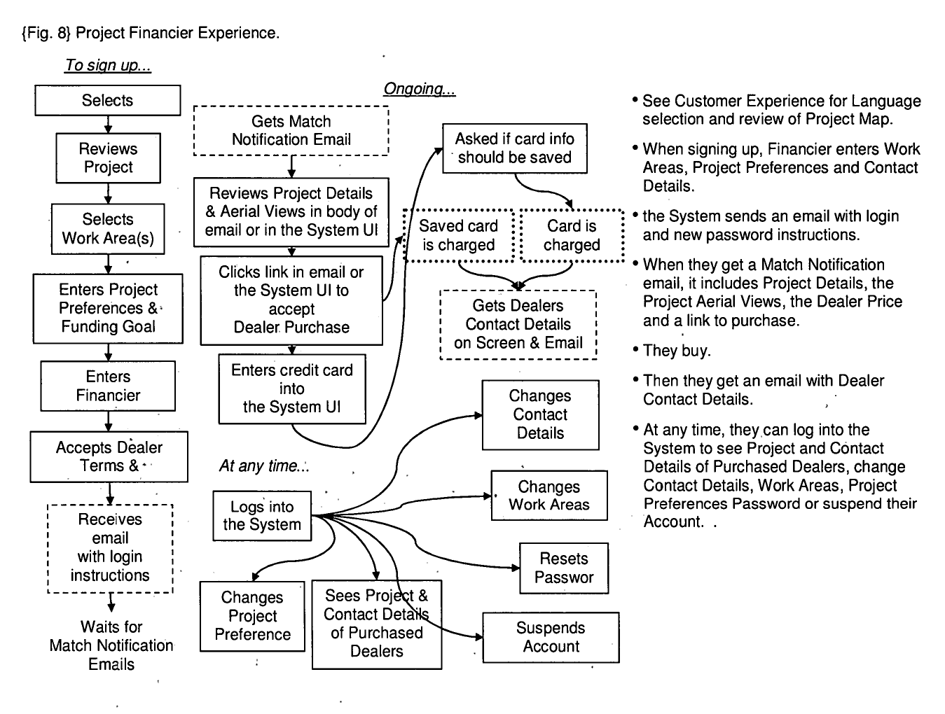

FIG. 9 Shows the Regional Liaison Experience.

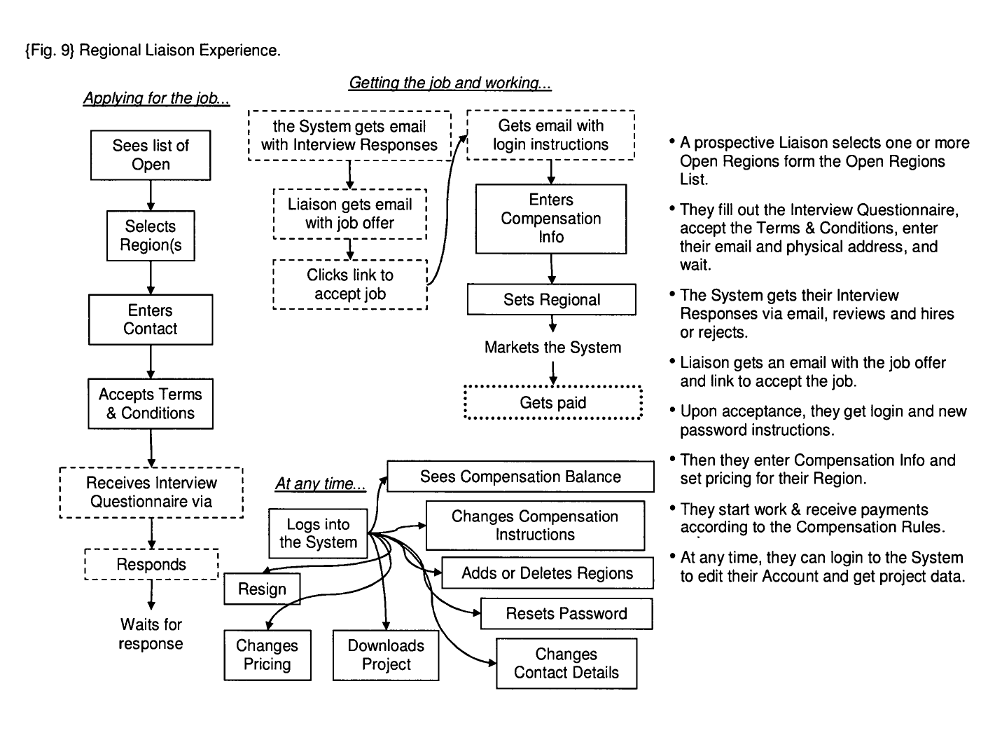

FIG. 10 Illustrates the process of profile creation, matchmaking and prioritizing user pairs (Matches).

### DESCRIPTION OF EMBODIMENTS

A preferred embodiment of the invention is a web based marketplace expressed in any one or combination of the following forms:
1. a web site compatible with typical web browsers, e.g., Chrome, Internet Explorer, Safari, Firefox, Android, but geared specifically for mobile versions of typical web browsers to facilitate use on mobile phones and tablet computers.
2. a mobile phone application (an “app”) compatible with typical mobile phone operating systems such Android, iOs and Windows Phone,
3. a social media application within typical social media platforms such as Facebook or Google Plus,
4. a traditional software application installed on desktop or laptop operating systems that interact with data and other components of the System that are supported by server infrastructure hosted in data centers (the cloud).
   The system is capable of being expressed in multiple embodiments simultaneously. For example, a user seeking a Solar Power Dealer could use the System through a mobile web browser while Solar Power Dealers who will eventually be matched with the user could use the System through a mobile phone application.

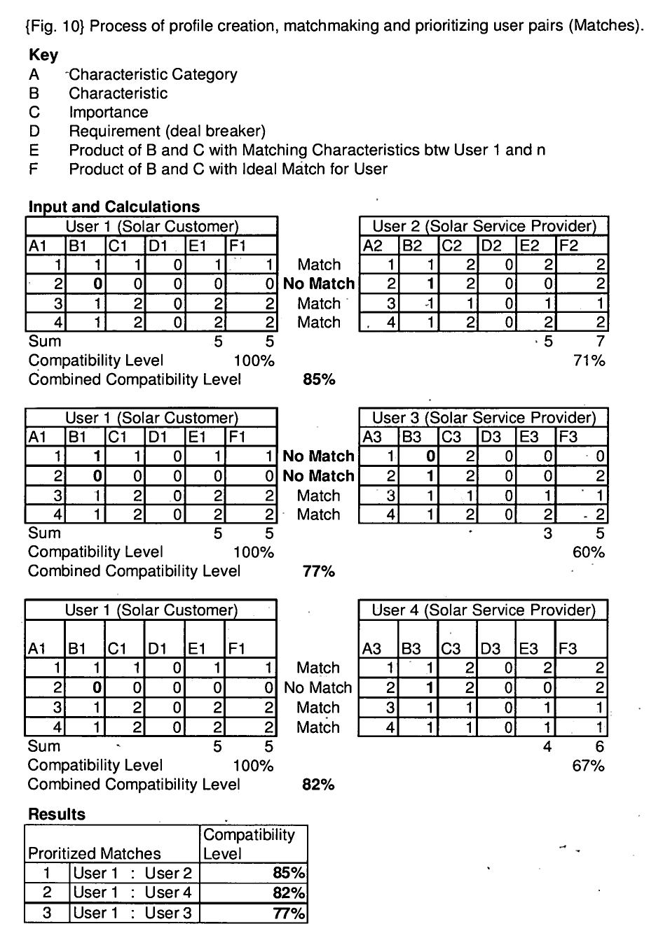

It is noteworthy that the profile generation and matchmaking calculation process described in FIG. 10 will be performed through a series of inputs and queries to a database combined with logical software operations and is applicable to all aforementioned embodiments.

1. A web-based, computer matchmaking and data sales system (System) for identifying and introducing parties endeavoring to provide, receive or finance solar power projects, services and related ancillary products and services.

2. The System of claim 1, further comprised of a human-machine interface.

3. The System of claim 1, further comprised of a database of continents, countries, states (or equivalent) and counties (or equivalent).

4. The System of claim 1, further comprised of a multi-lingual content database.

5. The System of claim 1, further comprised of a collection of logical software operations used to perform a matchmaking process.

6. The System of claim 1, further comprised of a subsystem used to specify pricing on a regional basis.

6. The System of claim 1, further comprised of a collection of subsystem used to track data sales.

7. The System of claim 1, further comprised of a subsystem used for processing payments in local currencies.

8. The matchmaking system of claim 1, where in, the human-machine interface is used to gather data for the generation of unique user profiles, present results of the matchmaking process (Matches), process monetary payments for the sale of matchmaking results, set pricing, track sales, manage users, and post messages to users.

9. The matchmaking system of claim 1, where in, the collection of logical software used to perform the following steps of the matchmaking process: comparison of user profiles to establish compatibility levels calculated from one user to the other in a user pair and vice versa, winnowing of user pairs based on incompatibilities that restrict commercial interaction, and prioritization of user pairs based on compatibility levels.
